(19) United States
(12) Patent Application Publication
(10) Pub. No.: US 2011/0157431 A1
(43) Pub. Date: Jun. 30, 2011

(54) Method and System for Directing Cameras

(76) Inventors: Yuri Ivanov, Arlington, MA (US); Abraham Goldsmith, Boston, MA (US); Christopher R. Wren, Arlington, MA (US)

(21) Appl. No.: 12/647,844

(22) Filed: Dec. 28, 2009

(51) Int. Cl. H04N 5/262; H04N 5/228

(52) U.S. Cl. 348/240.99; 348/222.1; 348/E05.031; 348/E05.055

(57) ABSTRACT

A system and a method for directing a camera based on time-series data are disclosed, wherein the time-series data represent atomic activities sensed by sensors in an environment, and wherein each atomic activity includes a time and a location at which the each atomic activity is sensed, comprising: providing a spatio-temporal pattern of the specified atomic activity, wherein the spatio-temporal pattern is based only on the time and the location of the atomic activities, such that a spatio-temporal sequence of the atomic activities forms the specified primitive activity; detecting, in the time-series data, a sensed primitive activity corresponding to the spatio-temporal pattern to produce a result, wherein the detecting is performed by a processor; and directing the camera based on the result.

### RELATED APPLICATIONS

This application is related to U.S. patent application Ser. No. (MERL-2104) 12/______ filed Dec. 28, 2009, entitled “Method and System for Detecting Events in Environments” filed by Yuri Ivanov, co-filed herewith and incorporated herein by reference.

### FIELD OF THE INVENTION

This invention relates generally to surveillance systems, and more particularly to directing cameras based on time-series surveillance data acquired from an environment.

### BACKGROUND OF THE INVENTION

Surveillance and sensor systems are used to make an environment safer and more efficient. Typically, surveillance systems detect events in signals acquired from the environment. The events can be due to people, animals, vehicles, or changes in the environment itself. The signals can be complex, for example, visual and acoustic, or the signals can sense temperature, motion, and humidity in the environment.

The detecting can be done in real-time as the events occur, or off-line after the events have occurred. Some real-time and the off-line processing requires means for storing, searching, and retrieving recorded events. It is desired to automate the processing of surveillance data to detect significant events.

Surveillance and monitoring of indoor and outdoor environments has been gaining importance in recent years. Currently, surveillance systems are used in a wide variety of settings, e.g., at homes, offices, airports, and industrial facilities. Most conventional surveillance systems rely on a single modality, e.g., a video, occasionally augmented with an audio. Such video-based systems generate massive amounts of video data. It is a challenge to store, retrieve, and detect events in a video. Computer vision procedures configured to detect events, or persons are either not fast enough for use in a real-time system, or do not have sufficient accuracy for reliable detection. In addition, video invades privacy of the occupants of the environment. For example, it may be illegal to acquire videos from designated spaces.

For some applications, it is desired to detect patterns in the surveillance data, e.g., human movement patterns, and provide an interface for identifying and selecting those patterns of interest.

### SUMMARY OF THE INVENTION

One embodiment of the invention disclose a method for directing a camera based on time-series data, wherein the time-series data represent atomic activities sensed by sensors in an environment, and wherein each atomic activity includes a time and a location at which the each atomic activity is sensed, comprising: providing a spatio-temporal pattern of the specified atomic activity, wherein the spatio-temporal pattern is based only on the time and the location of the atomic activities, such that a spatio-temporal sequence of the atomic activities forms the specified primitive activity; detecting, in the time-series data, a sensed primitive activity corresponding to the spatio-temporal pattern to produce a result, wherein the detecting is performed by a processor; and directing the camera based on the result.

Another embodiment of the invention disclose a system for directing a camera based on time-series data, wherein the time-series data represent atomic activities sensed by sensors in an environment, and wherein each atomic activity includes a time and a location at which the each atomic activity is sensed, comprising: means for providing a spatio-temporal pattern of the specified atomic activity, wherein the spatio-temporal pattern is based only on the time and the location of the atomic activities, such that a spatio-temporal sequence of the atomic activities forms the specified primitive activity; control module configured to detect, in the time-series data, a sensed primitive activity corresponding to the spatio-temporal pattern to produce a result; and means for directing the camera based on the result.

### BRIEF DESCRIPTION OF THE DRAWINGS

FIG. 1A is a block diagram of a system for detecting events in time-series data according to embodiments of an invention;

FIG. 1B is a block diagram of a method for grouping atomic activities into a pattern according to some embodiments of the invention;

FIG. 2 is a schematic of an example of a graphical user interface for specifying atomic activities according one embodiment of the invention;

FIG. 3 is a schematic of an example of an environment;

FIG. 4 is a schematic of an example of an interface for specifying primitive activities according one embodiment of the invention;

FIG. 5 is a block diagram of a system configured to signal alarms;

FIG. 6 is an example of an interface for specifying events according one embodiment of the invention;

FIG. 7 is a achematic of an example of a Petri net;

FIGS. 8A and 8B are examples schematics of a signaling processes of the Petri net; and

FIG. 9 is an example schematic of policies for scheduling cameras.

### DETAILED DESCRIPTION OF THE PREFERRED EMBODIMENT

### System

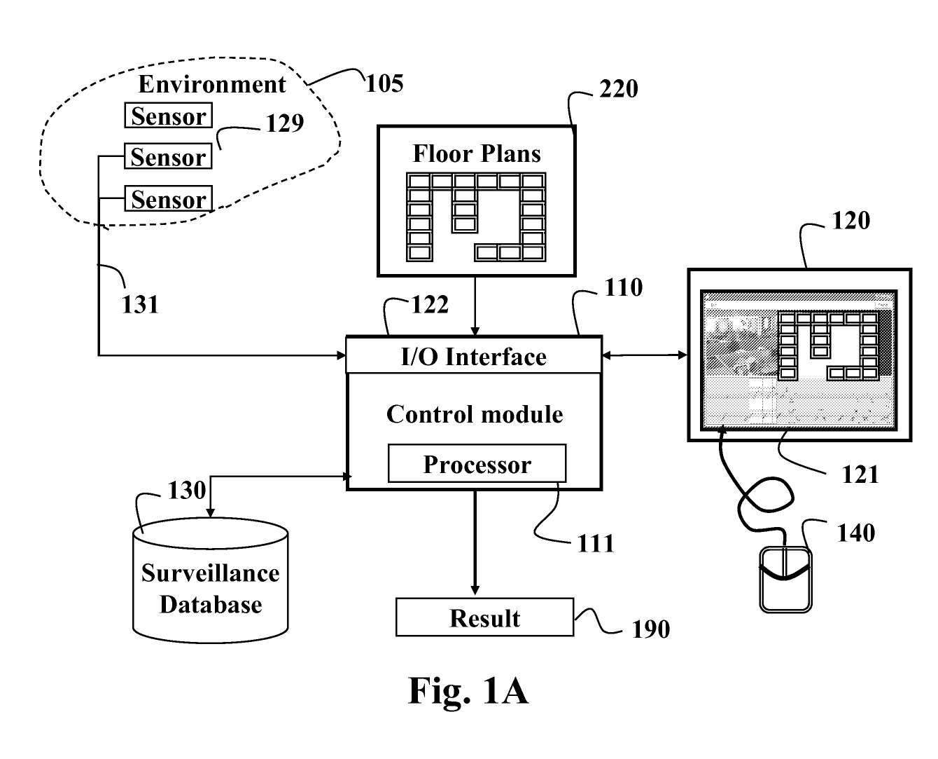

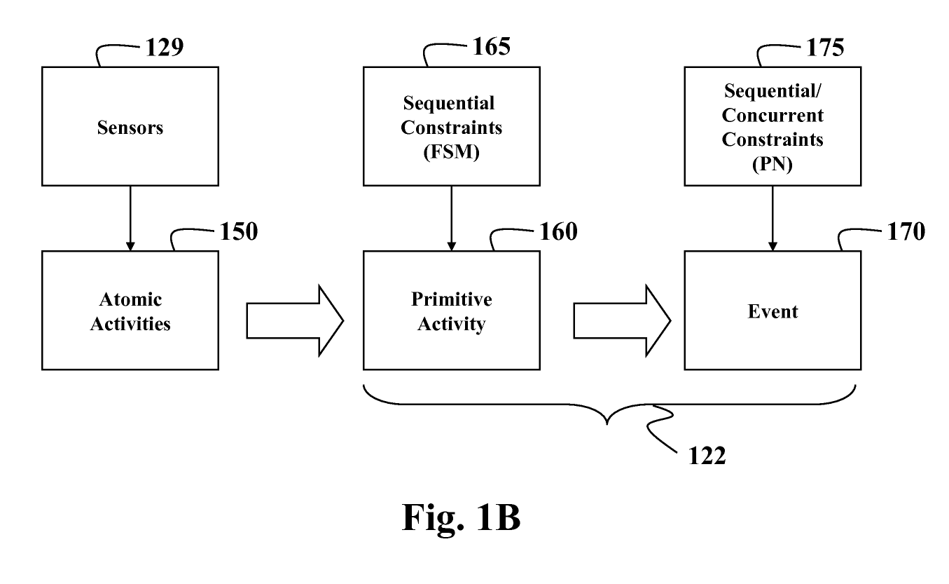

FIG. 1A shows a system and method for detecting events in time-series data acquired form an environment 105 according to embodiments of our invention. The system includes a control module 110 including a processor 111, an input and output interface 119. The interface is connected to a display device 120 with a graphical user interface 121, and an input device 140, e.g., a mouse or keyboard.

In some embodiments, the system includes a surveillance database 130. The processor 111 is conventional and includes memory, buses, and I/O interfaces. The environment 105 includes sensors 129 for acquiring surveillance data 131. As described below, the sensors include, but are not limited to, video sensors, e.g., cameras, and motion sensors. The sensors are arranged in the environment according to a plan 220, e.g., a floor plan for an indoor space, such that locations of the sensors are identified.

The control module receives the time-series surveillance data 131 from the sensors. The time-series data represent atomic activities sensed by the sensors in the environment. Each atomic activity is sensed by any one of the sensors and includes a time and a location at which the atomic activity is sensed. Examples of the atomic activity are a motion sensed by a motion sensor, or as can be observed in an image acquired by a camera. The location of the atomic activity is typically determined based on a location of the sensor on the plan 220. In one embodiment, the locations of the sensors and the atomic activities are stored in the surveillance database.

As shown in FIG. 1B, some embodiments of the invention group the atomic activities 150 into a pattern 122. The pattern includes a primitive activity 160 and/or an event 170. The primitive activity includes atomic activities and constraints on the atomic activities 165, wherein the constraints on the atomic activities are spatio-temporal, and sequential. The event includes the primitive activities and constraints on the primitive activities 175, wherein the constraints on the primitive activities are spatio-temporal, sequential and/or concurrent. In some embodiments, the event is mapped to a Petri net (PN).

The control module detects the pattern 122 in the time-series data 131 producing a result 190. In one embodiment, the pattern is acquired via the interface 121. Typically, the pattern is specified by a user via an input device 140.

Based on the result, a command is executed. The type of the command can be specified by the user. Non-limiting examples of the commands are displaying a relevant video on the interface, controlling, e.g., directing, a camera, signaling an alarm, and/or transmitting a message.

In one embodiment, the control module detects the pattern in real-time directly from the time-series data 131. In another embodiment, the time-series data are stored in the surveillance database, and the control module queries the database. In one embodiment, the control module detects the pattern upon receiving the atomic activity. In yet another embodiment the control module detects the pattern periodically.

Sensors

The time-series data 131 are acquired by a network of sensors 129. The sensors can be heterogeneous or homogeneous. The sensors 129 can include video cameras and motion detectors. Other types of sensors as known in the art can also be included, e.g., temperature sensors and smoke detectors.

Because of the relative high cost of the cameras and the low cost of the sensors, the number of sensors can be substantially larger than the number of cameras; i.e., the cameras are sparse and the detectors are dense in the environment. For example, one area viewed by one camera can include dozens of detectors. In a large building, there could be hundreds of cameras, but thousands and thousands of detectors. Even though the number of sensors can be relatively large, compared with the number of cameras, the amount of data acquired by the sensors is small compared with the video data.

In one embodiment, the cameras do not respond to activities sensed in a fixed field of view, but simply record images of the environment. It should be noted, that the videos can be analyzed using conventional computer vision techniques. This can be done in real-time, or off-line after the videos are acquired. The computer vision techniques include object detection, object tracking, object recognition, face detection, and face recognition. For example, the system can determine whether a person entered a particular area in the environment, and record this as a time-stamped event in the database.

However, in another embodiment, the cameras include pan-tilt-zoom (PTZ) cameras configured to orient and zoom the camera in response to the atomic activities detected by sensors.

Atomic Activity

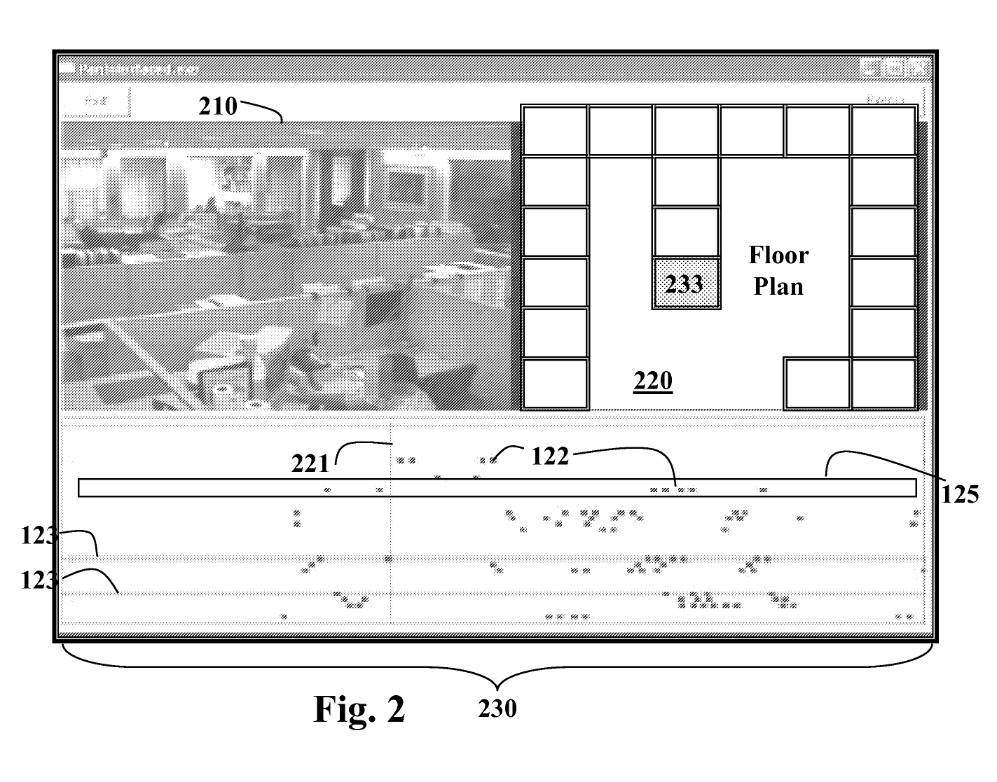

FIG. 2 shows the interface 121 according one embodiment of the invention. The interface includes a video playback window 210 at the upper left, a floor plan window 220 at the upper right, and an event time line window 230 along a horizontal bottom portion of the screen. The video playback window 210 can present video streams from any number of cameras. The selected video can correspond to the atomic activities 233 identified by a user via the interface 121.

A timeline 230 shows the atomic activities in a “player piano roll” format, with time running from left to right. A current time is marked by a vertical line 221. The atomic activities for the various detectors are arranged along the vertical axis. The rectangles 122 represent the atomic activities (vertical position) being active for a time (horizontal position and extent). On each horizontal arrangement for a particular sensor is a track outlined by a rectangular block 125.

The visualization of the video has a common highlighting scheme. The locations of the atomic activities 233 can be highlighted with color on the floor plan 220. Sensors that correspond to the atomic activities are indicated on the timeline by horizontal bars 123 rendered in the same color. A video can be played that corresponds to events, at a particular time, and a particular area of the environment.

Primitive Activity

According to one embodiment, the atomic activities are related in space and time to form the primitive activity. For example, a person walking down a hallway causes a subset of the motion sensors mounted in the ceiling to signal atomic activities serially at predictable time intervals, depending on a velocity of the person.

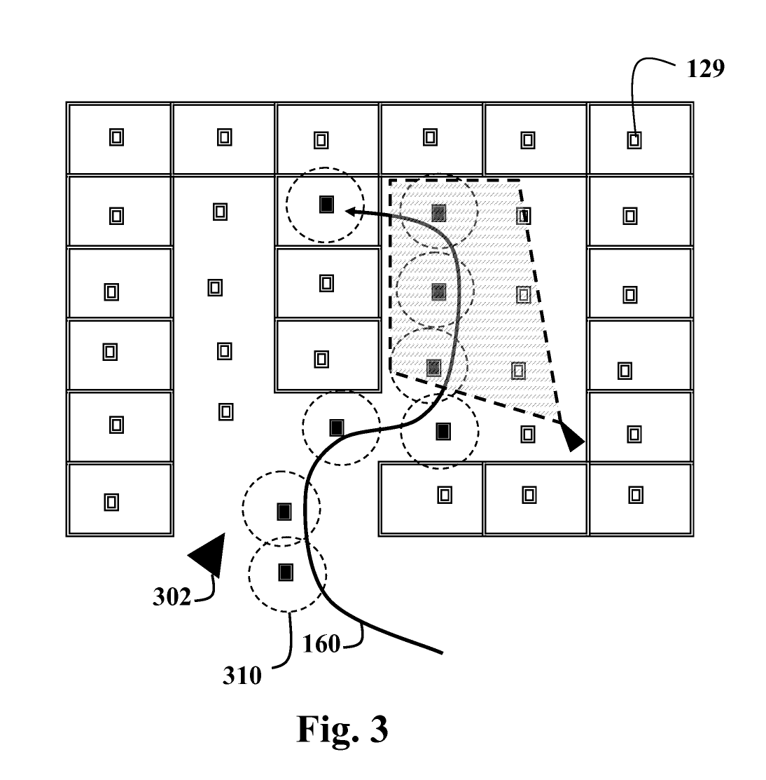

FIG. 3 shows an example environment. The location of sensors 129 are indicated by rectangles. The dashed lines 310 approximately indicate a range of the sensors. The system selects sensors whose range intersects a specified primitive activity. The locations of cameras are indicated by triangles 302. A user can specify the primitive activity 160, e.g., a path that a person would follow to move from an entryway to a particular office, by selecting on the interface a corresponding subset of the sensors, e.g., filled rectangles.

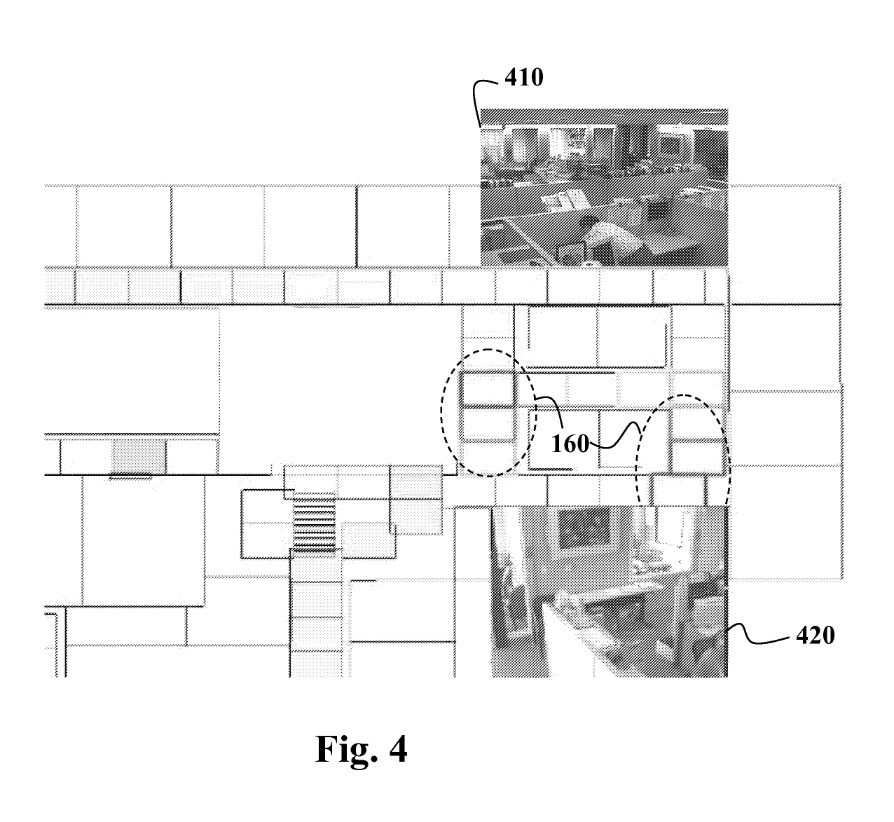

FIG. 4 shows an example of user interface for specifying the primitive activities 160. For example, the primitive activity can be specified by selecting a subset of the sensors or by specifying a portion of the plan. When the primitive activities are detected, in one embodiment, relevant videos 410 and 420 are displayed.

Live Alarms

One requirement of an on-line surveillance system is the ability to set and signal “live alarms” immediately. Live alarms allow a user to acquire visual evidence of activities of interest as the activities happen in the environment. The alarms can correspond to abnormal activities such as someone entering an unauthorized space, or as an intermediate step toward performing some other task such as counting the number of people who access a printer-room during the day.

One embodiment uses the motion sensors to detect the primitive activities, and to direct the PTZ camera at the activities of interest. Typically, the primitive activities correspond to a sequence of sensor activations. The sequence of activations can be specified by the user by tracing the path 160 of interest on the plan forming an ordered sequence of a subset of the sensors. The alarm “goes off” whenever the specified arrangement of activations occurs along the path.

In one embodiment, the primitive activity is modeled as a finite state machine (FSM), where each sensor acts as an input, and the specified arrangement is parsed by the FSM. For incoming sensor data, all specified FSMs are updated. When one of the FSM detects the specified arrangement, an alarm is signaled, and a command is sent to the control module to direct the cameras toward the location of the sensor that caused the alarm. After the camera(s) are directed to the appropriate location, visual evidence of the activity at the scene is acquired for further image analysis.

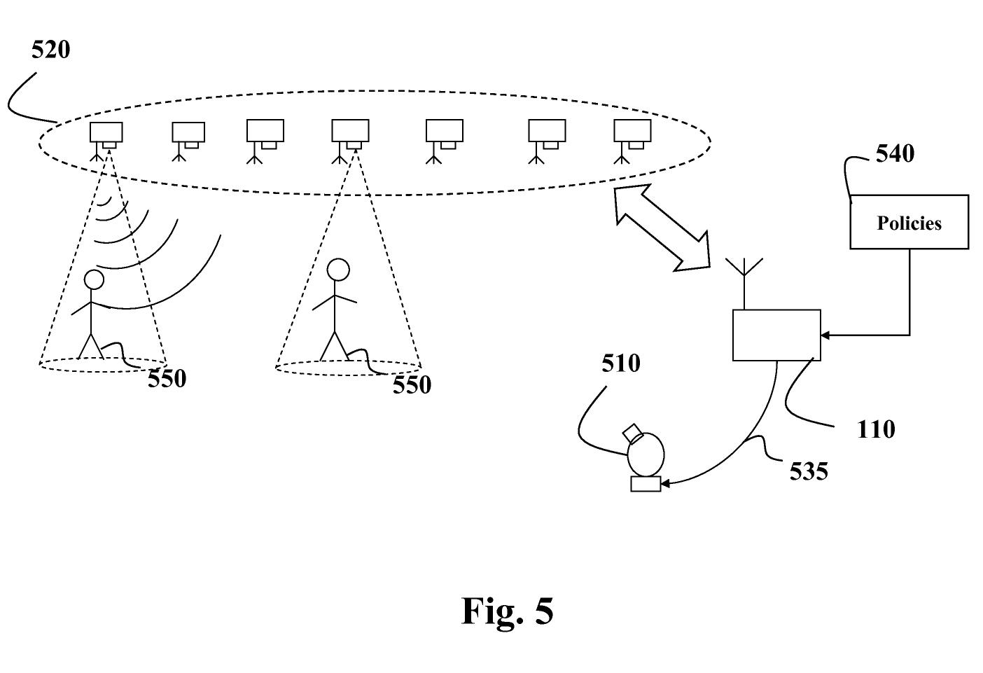

FIG. 5 shows an example of a system configured to signal alarms. The system includes a camera 510, sensors 520, and the control module 110. In various embodiments, the camera 510 is fixed or moveable, e.g., a web-enabled PTZ video camera. The system includes one or multiple cameras. The sensors include various types of sensing devices, e.g., motion sensors. The sensors can are configured to detect and to transmit the atomic activities to the control module via wired or wireless links.

The control module, upon receiving the atomic activity, detects the primitive activity and outputs a command 535 to the camera. The command may include navigation parameters of the camera optimal to acquire the activity of interest. In one embodiment, the control module uses a policy module 540 to determine the command. In another embodiment, the control module queries the surveillance database 130 to determine the command. An example of the command is a tracking a movement of a user 550 sensed by the sensors 520.

As described in more details below, in one embodiment, the control module detects the events to issue the command.

Policy Module

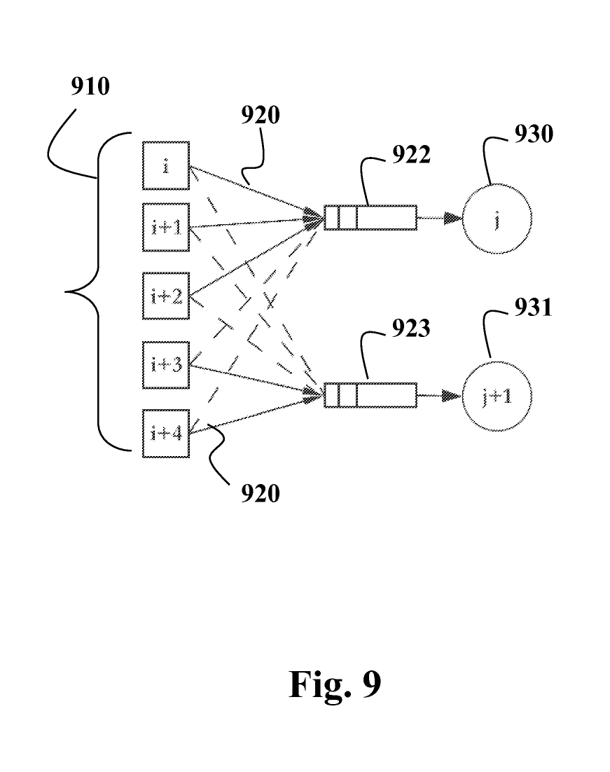

FIG. 9 shows an example of policies for scheduling the cameras. In some embodiments, the activities sensed by sensors are regarded as a request for a resource, wherein the resource is the camera 930, e.g., the PTZ camera. All incoming requests are organized in a queues 922-923. For each time-interval, e.g., about 10 ms, the control module determines a set of the sensors that are active in that time-interval. The latest request is appended to a set A^{(t)} of sensor 910 activated during the time-window centered at t. For each sensor in the activation set Aᵢ^{(t)}, we determine a visibility set vis(Aᵢ^{(t)}).

In general, there is more than one camera 930-931 that can observe the corresponding location of the activity. For each ordered pair of sensor activation and camera, we define a cost of allocation. If a camera is not in the visibility set Aᵢ^{(t)}, the cost of allocation is infinity. For cameras in the visibility set vis(Aᵢ^{(t)}), the allocation cost is a change in PTZ parameters required to acquire the activity sensed by the sensor, i.e., a required change in the state of the camera to acquire the sensed primitive activity.

If Sₖ^{(t)} is a current state of the camera Cₖεvis(Aᵢ^{(t)}), ŝₖ is the state required to observe the sensor. In one embodiment, Ŝₖ is determined from a calibration database. Then, the cost of allocation

cost(Aᵢ^{(t)},Cₖ)=d(Sₖ^{(t)},Ŝₖ),

where d(.) is a distance metric on a state-space of the cameras.

In another embodiment, the state of a camera is defined as the current PTZ values, i.e., Sₖ^{(t)}=(p, t, z). In one variation of this embodiment, instead of a zoom parameter, image-analysis is used to enhance a resolution of images of faces. Thus, the distance metric d(,) is defined as a Euclidean norm between the current and required pan-and-tilt values. Accordingly, the required parameters to observe the i^{th} event Aᵢ^{(t)} is Ŝₖ=(\hat{p},\hat{t}), and the cost is

cost(Aᵢ^{(t)},Cₖ)=\sqrt{(p−\hat{p})²+(t−\hat{t})²}.

Events

In some embodiments, it is desired to specify more complex patterns. As defined herein, the event is a pattern of activities involving multiple primitive activities and constraints on the primitive activities, wherein the constraints on the primitive activities are spatio-temporal, sequential and/or concurrent. In some embodiments, the event is mapped to a Petri net (PN) as described below.

General activities in indoor and outdoor environments often involve a number of people and objects and usually imply some form of temporal sequencing and coordination. For example, the activity of two people meeting in the lounge of a large office space and exchanging an object, e.g., a briefcase, includes several primitives:

two people enter the lounge independently;

the people stop near each other;

the object is transferred from one person to the other; and

the people leave.

The activity starts with two independent movements, which occur concurrently. The movements come to the temporal synchronization point, at which time the suitcase is exchanged, and then diverge again into two independent motions as the people leave the room. Such situations where observations form independent streams coming into synchrony at discrete points in time are modeled by embodiments of the invention using a formalism of Petri nets.

Petri Nets

Petri nets (PN) is a tool for describing relations between conditions and events. Some embodiment use the PN to model and analyze behaviors such as concurrency, synchronization and resource sharing.

Formally, the Petri net is defined as

PN={P,T,→},

where P and T are finite disjoint sets of places and transitions respectively i.e. P∩T=Ø, and operator → is a relation between places and transitions, i.e., →⊂(P×T)∪(T×P).

Also, in the PN there exists at least one end place and at least one start place. A preset of a node xεP∪T is a set. x={y|y→x}. A postset of the node xεP∪T is a set x′={y|x→y}.

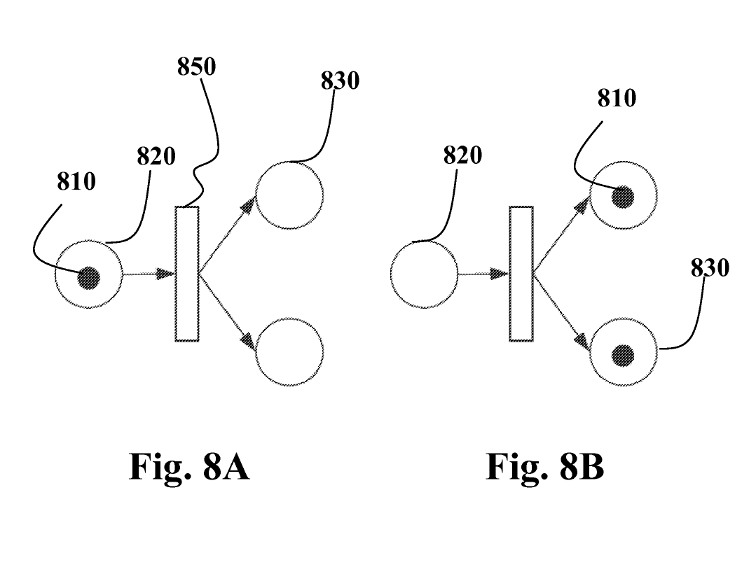

FIGS. 8A and 8B show a firing process corresponding to the cases of concurrency and synchronization respectively. Dynamics of the Petri net are represented by markings. A marking is an assignment of tokens to the places, e.g., input places 820 and an output places 830, of the Petri net. The execution of the Petri net is controlled by a current marking.

A transition 850 is enabled if and only if all the input places have a token. When a transition is enabled, the transition can fire. Fire is a term of art used when describing Petri nets. In a simplest case, all the enabled transitions can fire. The embodiments also associate other constraints to be satisfied before an enabled transition can fire. When a transition fires, all enabling tokens are removed and the token is placed in each of the output places of the transition (the postset).

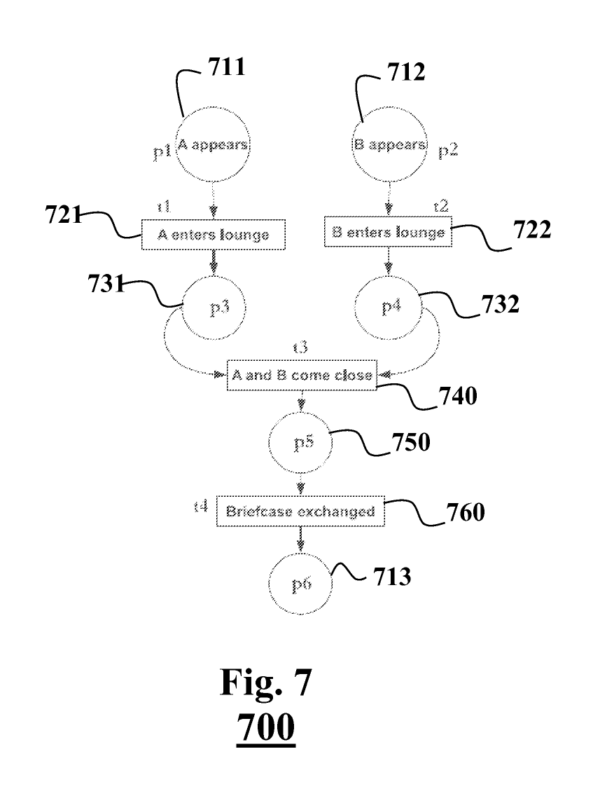

FIG. 7 shows an example of concurrency, synchronization and sequencing constraints mapped to the PN 700. In this PN, the places are labeled p₁ . . . p₆, and the transitions are labeled t₁ . . . t₄. The places p₁ 711 and p₂ 712 are the start places and p₆ 713 is the end place. When a person A is detected in the start place 711, a token is placed in the place p₁. Accordingly, the transition t₁ 721 is enabled, but does not fire until the constraint associated with the transition t₁ is satisfied, e.g., the person enters an office lounge. After this happens, the token is removed from the place p₁ and placed in the place p₃ 731. Similarly, when another person B enters is detected at the start place 712, a token is placed in the place p₂ and the transition t₂ 722 fires after the person B enters the lounge. Accordingly, the token is removed from the place p₂ and placed in the place p₄ 732.

When each of the enabling places 731 and 732 of a transition t₃ 740 has the token, the transition t₃ is ready to fire when the associated constraint occurs, i.e., when the two persons A and B come near each other.

Then, the transition t₃ fires and both tokens are removed and a token is placed in the output place p₅ 750. Now a transition t₄ 760 is enabled and ready to fire. The transition t₄ fires when the briefcase is exchanged between the two people, and the token is removed from the place p₅ and placed in the end place p₆. When the token reaches the end place, the PN 700 is completed.

The Petri net is used by some embodiments to represent and recognize events in the time-series data. Those embodiments define the events based on primitive actions and constraints for those actions. In the embodiment, the primitive actions are human movement patterns, which are detected using the sensors. In some embodiments, the constraints are described using conjunction operators, e.g., “AND,” “OR,” “AFTER,” “BEFORE.” The events and constraints are mapped to the Petri nets.

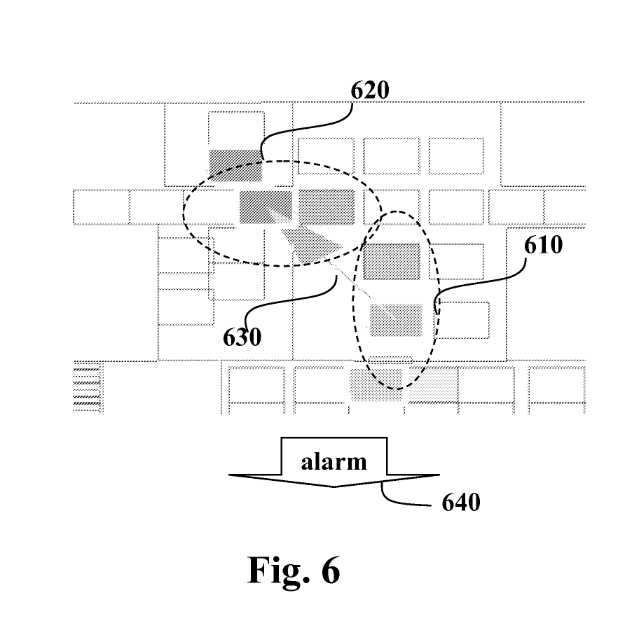

FIG. 6 shows an example of the interface 121 configured to specify the events. Using this interface, the user can select the primitive activities 610 and 620 and specified a constraint 630, e.g., “AFTER,” i.e., the primitive activity 620 is happened after the primitive activity 610. In one embodiment, if the event is detected, an alarm 640 is triggered.

It is to be understood that various other adaptations and modifications may be made within the spirit and scope of the invention. Therefore, it is the object of the appended claims to cover all such variations and modifications as come within the true spirit and scope of the invention.

We claim:

1. A method for directing a camera based on time-series data, wherein the time-series data represent atomic activities sensed by sensors in an environment, and wherein each atomic activity includes a time and a location at which the each atomic activity is sensed, comprising the steps of:
providing a spatio-temporal pattern of the specified atomic activity, wherein the spatio-temporal pattern is based only on the time and the location of the atomic activities, such that a spatio-temporal sequence of the atomic activities forms the specified primitive activity;
detecting, in the time-series data, a sensed primitive activity corresponding to the spatio-temporal pattern to produce a result, wherein the detecting is performed by a processor; and
directing the camera based on the result.

2. The method of claim 1, wherein the atomic activity is a motion sensed by the sensor at the time, and the location is a location of the sensor.

3. The method of claim 1, wherein the directing further comprising:
directing the camera based on a policy.

4. The method of claim 1, further comprising:
detecting the spatio-temporal pattern in real time upon sensing a new atomic activity.

5. The method of claim 1, wherein the time-series data are stored in a surveillance database, further comprising:
querying the surveillance database to detect the spatio-temporal pattern.

6. The method of claim 1, wherein the sensors form a network of heterogeneous sensors.

7. The method of claim 1, further comprising:
providing an interface configured to specify the specified primitive activity.

8. The method of claim 7, wherein the interface identifies the sensors such that the specified primitive activity is selected by specifying a subset of the sensors.

9. The method of claim 7, wherein the interface identifies a plan such that the specified primitive activity is selected by specifying a portion of the plan.

10. The method of claim 1, further comprising:
modeling the specified primitive activity as a finite state machine (FSM) of a sequence of a subset of the sensors, wherein each sensor in the subset is an input to the FSM.

11. The method of claim 1, further comprising:
specifying the spatio-temporal sequence as an ordered sequence of a subset of the sensors.

12. The method of claim 1, wherein the spatio-temporal pattern includes a plurality of specified atomic activities.

13. The method of claim 12, further comprising:
specifying constraints on the plurality of specified atomic activities using conjunctions operators including “AND,” “OR,” “AFTER,” and “BEFORE” operators.

14. The method of claim 1, wherein the camera is a pan-tilt-zoom (PTZ) camera, wherein the directing further comprising:
orienting and/or zooming the camera based on the result.

15. The method of claim 14, further comprising:
appending the sensed primitive activity to a queue;
determining a camera from a set of the cameras such that the sensed primitive activity is within a visibility of the camera; and
determining parameters of the camera optimal to acquire the sensed primitive activity.

16. The method of claim 3, wherein the camera is a pan-tilt-zoom (PTZ) camera having PTZ parameters, and the directing further comprising:
allocating a cost of a change in the PTZ parameters required to acquire the sensed primitive activity; and
changing the PTZ parameters based on the cost.

17. A system for directing a camera based on time-series data, wherein the time-series data represent atomic activities sensed by sensors in an environment, and wherein each atomic activity includes a time and a location at which the each atomic activity is sensed, comprising:
means for providing a spatio-temporal pattern of the specified atomic activity, wherein the spatio-temporal pattern is based only on the time and the location of the atomic activities, such that a spatio-temporal sequence of the atomic activities forms the specified primitive activity;
control module configured to detect, in the time-series data, a sensed primitive activity corresponding to the spatio-temporal pattern to produce a result; and
means for directing the camera based on the result.

18. The system of claim 17, further comprising:
a policy module generating a policy for the directing of the camera.

19. The system of claim 17, further comprising:
a display device configured to display an interface suitable for specifying the specified atomic activity.

20. The system of claim 17, further comprising:
a surveillance database for storing the time-series data.
